(19) United States
(12) Patent Application Publication
(10) Pub. No.: US 2020/0282393 A1
(43) Pub. Date: Sep. 10, 2020

(54) MODULAR AND EXPANDABLE LOW FLOW PUMPING ASSEMBLIES

(71) Applicant: Advanced Solutions Life Sciences, LLC, Louisville, KY (US)

(72) Inventor: Scott Douglas Cambron, Louisville, KY (US)

(73) Assignee: Advanced Solutions Life Sciences, LLC, Louisville, KY (US)

(21) Appl. No.: 16/811,808

(22) Filed: Mar. 6, 2020

Related U.S. Application Data
(60) Provisional application No. 62/815,691, filed on Mar. 8, 2019.

(51) Int. Cl. B01L 3/00

(52) U.S. Cl. CPC B01L 3/50273; B01L 2300/0829; B01L 3/502738

(57) ABSTRACT

Modular pump assemblies according to the present disclosure include a plurality of mounting frames configured to be stackable with one another in a modular configuration, and an array of pumps mounted to each of the plurality mounting frames, the array of pumps comprising an array of inlet pumps configured to be fluidically coupled a plurality of fluid inlet paths of a well-plate manifold or an array of fluid outlet pumps configured to be fluidically coupled to a plurality of fluid outlet paths of the well-plate manifold, or any combination thereof.

### CROSS-REFERENCE TO RELATED APPLICATIONS

The present application claims the benefit U.S. Provisional Application No. 62/815,691, filed Mar. 8, 2019, the entirety of which is hereby incorporated by reference.

### TECHNICAL FIELD

The present specification generally relates to modular and expandable low flow pumping assemblies and, more specifically, modular and expandable low flow pumping solutions for discrete flow control and integration into multichannel perfusion networks.

### BACKGROUND

Well-plates may be flat plates with multiple separate wells formed therein. The individual wells may be used in a variety of capacities. For example, each well may be used as a Petri Dish for growing and/or printing biologic structures. Oftentimes fluid is added and/or removed from the various wells of the well-plate. For example, in some cases it may be advantageous to perfuse a structure within a well of a well-plate with a fluid. Traditionally fluid may be added to a well-plate using a pipettes, syringes, or similar structures. However, because well-plates may define arrays of wells larger than 96 wells, such perfusion of individual wells may prove to be tedious. Moreover, it may be desirable to have the ability to generate independent flow control to each discrete well or to separate groups of wells within the well-plate.

Accordingly, a need exists for alternative modular and expandable low flow pumping solutions for discrete flow control and integration into multichannel perfusion networks.

### SUMMARY

In one embodiment, a modular pump assembly includes a plurality of mounting frames configured to be stackable with one another in a modular configuration, and an array of pumps mounted to each of the plurality mounting frames, the array of pumps comprising an array of inlet pumps configured to be fluidically coupled a plurality of fluid inlet paths of a well-plate manifold or an array of fluid outlet pumps configured to be fluidically coupled to a plurality of fluid outlet paths of the well-plate manifold, or any combination thereof.

In another embodiment, a perfusion assembly includes a well-plate assembly, a modular pump assembly, a fluid inlet line, and a fluid outlet line. The well-plate assembly includes a well-plate defining a plurality of well-groups each comprising one or more wells, and a well-plate manifold including a plurality of fluid inlet paths and fluid outlet paths corresponding to each well-group. The modular pump assembly includes a plurality of mounting frames configured to be stackable with one another in a modular configuration, and an array of pumps mounted to each of the plurality mounting frames. The array of pumps comprising an array of inlet pumps fluidically coupled to the plurality of fluid inlet paths, an array of outlet pumps fluidically coupled to plurality of fluid outlet paths, or any combination thereof.

In yet another embodiment, a method of delivering fluid to a well-plate assembly includes fluidically coupling the well-plate assembly to a modular pump assembly. The well-plate assembly includes a well-plate defining a plurality of well-groups each comprising one or more wells, and a well-plate manifold including a plurality of fluid inlet paths and fluid outlet paths corresponding to each well-group. The modular pump assembly includes one or more mounting frames, and an array of pumps mounted to the one or more mounting frames, the array of pumps comprising an array of inlet pumps fluidically coupled to the plurality of fluid inlet paths, an array of outlet pumps fluidically coupled to plurality of fluid outlet paths, or any combination thereof. The method further includes fluidically coupling the modular pump assembly to one or more fluid reservoirs, and controlling fluid flow into and/or out of one or more of the well-groups by selectively activating, with one or more processors, a pump of the array of pumps associated with each of well-groups.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically illustrates a perfusion assembly, according to one or more embodiments shown and described herein;

FIG. 2 schematically illustrates an alternative perfusion assembly, according to one or more embodiments shown and described herein;

FIG. 3 schematically illustrates a control system for controlling flow with a modular pump assembly, according to one or more embodiments shown and described herein;

FIG. 4 depicts a flow chart depicting a method of delivering fluid to a well-plate assembly, according to one or more embodiments shown and described herein;

FIG. 5 depicts a modular pump assembly, according to one or more embodiments shown and described herein;

FIG. 6A depicts an expanded modular pump assembly, according to one or more embodiments shown and described herein;

FIG. 6B depicts another expanded modular pump assembly, according to one or more embodiments shown and described herein;

FIG. 7 depicts another modular pump assembly, according to one or more embodiments shown and described herein;

FIG. 8A depicts a front perspective view of an array of pump pairs of the modular pump assembly of FIG. 7, according to one or more embodiments shown and described herein;

FIG. 8B schematically depicts a rear perspective view of the array of pump pairs of FIG. 8A, according to one or more embodiments shown and described herein;

FIG. 9 depicts an exploded view of the array of pump pairs FIG. 8A, according to one or more embodiments shown and described herein;

FIG. 10 depicts an exploded view of a cartridge of the array of pump pairs of FIG. 8A, according to one or more embodiments shown and described herein;

FIG. 11A depicts a front perspective view of the modular pump assembly of FIG. 7, according to one or more embodiments shown and described herein;

FIG. 11B depicts a rear perspective view of the modular pump assembly of FIG. 11A, according to one or more embodiments as shown and described herein; and

FIG. 11C depicts an exploded view of the modular pump assembly of FIG. 11A, according to one or more embodiments shown and described herein.

### DETAILED DESCRIPTION

The present disclosure is directed to a modular and expandable low flow pumping solution for discrete flow control and integration into multichannel perfusion networks. Such multi-channel perfusion networks (e.g., well-plate and fluid manifold assemblies) are described in greater detail in U.S. patent application Ser. No. 16/135,299, entitled “Well-Plate and Fluidic Manifold Assemblies and Methods,” filed Sep. 19, 2018, hereby incorporated by reference in its entirety. Pumping solutions/assemblies as described herein have the ability to generate independent flow control to each discrete well within the well-plate/manifold assembly to distribute a fluid, such as but not limited to cell culture media, water, blood, blood serum, etc., to biological structures printed or lab grown within well-plates of varying capacity (i.e. 6, 12, 24, 48, 96 wells, etc.). While fluid distribution to biological structures printed or lab grown within well-plates are one contemplated application of the present disclosure, other applications of the present pumping solutions/assembly are contemplated and possible.

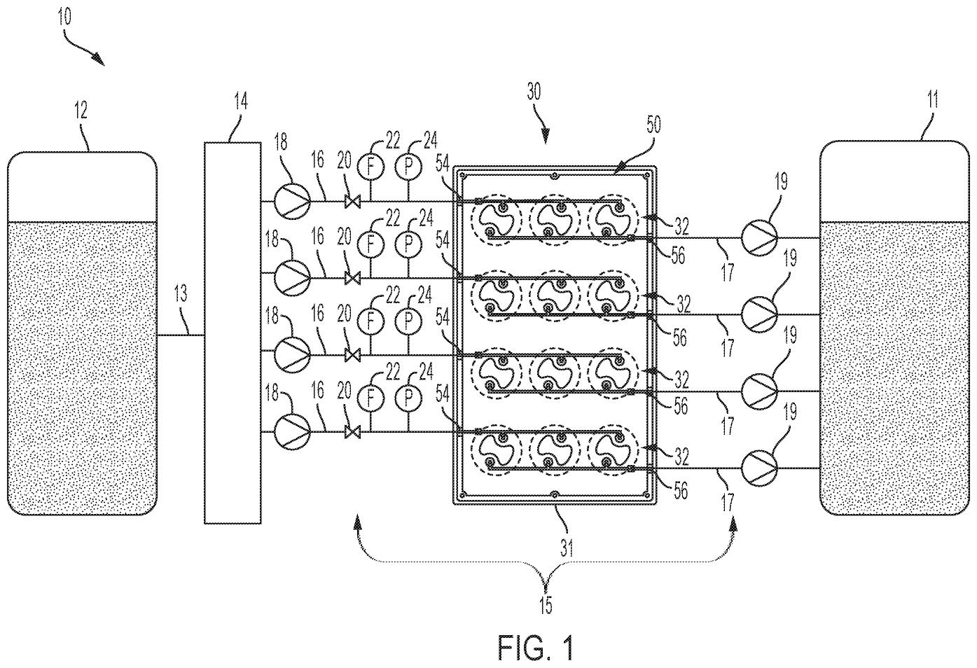

Pumping solutions and assemblies may incorporate, but are not limited to, an array of pumps, valves, flow sensors, and/or pressure sensors to supply discrete flow to each well or to predetermined groups of wells of a well-plate. The unit may be devised to be modular so that it can be expandable to larger array of hardware to accommodate each well-plate capacity (e.g., 6, 12, 24, 48, 96 wells, etc.). For example, FIG. 1 schematically illustrates perfusion assembly for the delivery of fluid to the various wells of a well-plate. For example, the well-plate may define a plurality of well-groups each having one or more wells. A well-plate manifold includes a plurality of fluid inlet and/or outlet paths corresponding to a well-group for the delivery of fluid into and/or out of each well-group. A modular pump assembly may include an array of pumps. The array of pumps may include an array of inlet pumps configured to push fluid through the well-groups of a well-plate, an array of outlet pumps configured to pull fluid through the well-groups of the well-plate, and/or any combination thereof. For example, in some embodiments the array of pumps including one or more pump pairs each including an inlet pump and an outlet pump. Each pair corresponds to a well-group of the well-plate. A fluid inlet line couples the inlet pump to a fluid inlet path of the well-plate manifold. In some embodiments, a fluid outlet line couples the outlet pump to a fluid outlet path of the well-plate manifold. In this way, flow to each group may be independently controlled. Accordingly, in some embodiments, fluid delivery into a well of a well-plate and/or extraction of fluid from the well of the well-plate may be independently controlled. This may allow operators to apply various conditions or parameters to different wells within the same well-plate. These and additional embodiments will be described in greater detail herein.

Referring now to FIG. 1, a perfusion assembly 10 may include a well-plate assembly 30 and a modular pump assembly 15 that is configured to fluidically couple the well-plate assembly 30 to one or more fluid reservoirs 12.

Well-plate assemblies are described in greater detail in U.S. patent application Ser. No. 16/135,299, entitled “Well-plate and Fluidic Manifold Assemblies and Methods,” filed Sep. 19, 2018, hereby incorporated by reference in its entirety. In particular, a well-plate assembly 30 includes a well-plate 31 defining a plurality of well-groups 32. Each well-group 32 may include one or more wells. It is noted that well-plates according to the present disclosure may have 6 or more wells, 12 or more wells, 24 or more wells, 48 or more wells, 96 or more wells, etc. As will be described in greater detail herein, the modular pump assembly 15 may be expanded to provide individualized flow control to any number of wells or well-groups 32 within a well-plate 31.

In some use cases, wells may be used for growing and/or printing biological constructs. However, other uses are contemplated and possible. Printed biological constructs and methods of fabrication are further described in U.S. patent application Ser. No. 15/202,675, filed Jul. 6, 2016, entitled “Vascularized In Vitro Perfusion Devices, Methods of Fabricating, and Applications Thereof,” hereby incorporated by reference in its entirety. Such printed biological constructs may be formed directly within a well of a well-plate 31. For example, a 3-D printer (e.g., bioassemblybot® 3-D printing and robotics systems such as described in U.S. patent application Ser. No. 15/726,617, filed Oct. 6, 2017, entitled “System and Method for a Quick-Change Material Turret in a Robotic Fabrication and Assembly Platform,” hereby incorporated by reference in its entirety and as available from Advanced Solutions Life Sciences, LLC of Louisville, Ky.) may be used to fabricate biological constructs within each of the wells of the well-plate 31 with channel structures formed therein. The channel structures may be perfused with culture media solution or other fluid by the modular pump assembly 15. It may be desirable to provide various flow conditions to individual constructs within a well-plate 31. Accordingly, the modular pump assembly 15 is configured to provide independent flow control to separate groupings of wells and/or each individual well such that flow parameters to each well or well-group 32 within a single well-plate 31 may be varied from one another.

A well-plate manifold 50 may be positioned over the well-plate 31 and provide fluid flow paths into and out of each of the wells of the well-plate 31. For example, the well-plate manifold 50 may provide a plurality of fluid inlet paths 54 and a plurality of fluid outlet paths 56. The plurality of fluid inlet paths 54 may provide an inlet into the wells of each well-group 32 and the plurality of fluid outlet paths 56 may provide an outlet for fluid to be removed from each well-group 32 to a receptacle 11 or other location. It is noted that in illustrated embodiment, there are three wells in each group, however, a greater or fewer number of wells may be in each group without departing from the scope of the present disclosure. For example, each individual well may be a well-group 32 and may have a dedicated fluid inlet and outlet path, such that flow to each individual well may be separated controlled.

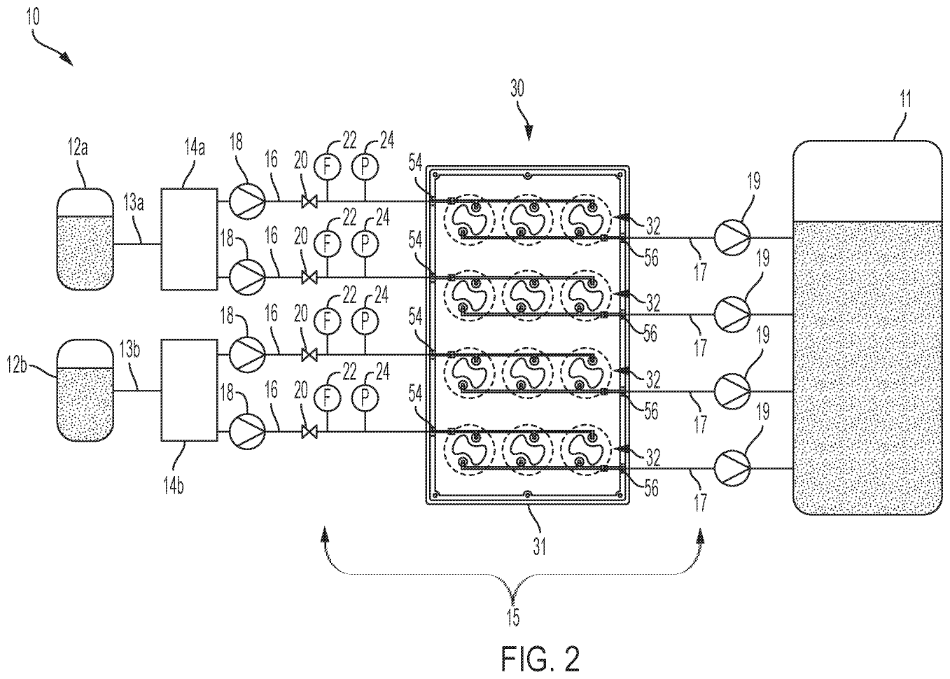

The inlet pumps 18 fluidically couple each well-group 32 to one or more fluid reservoirs 12. Each inlet pump 18 may be fluidically coupled to the same fluid reservoir 12 as illustrated in FIG. 1. However, it is contemplated that the inlet pumps 18 may be fluidically coupled to different fluid reservoirs 12. For example, FIG. 2 illustrates a first portion of the fluid inlet pumps 18 fluidically coupled to a first fluid reservoir 12a and a second portion of the fluid inlet pumps 18 fluidically coupled to a second fluid reservoir 12b. Accordingly, different fluid reservoirs may be used for supplying fluid to different well-groups 32. In some embodiments, each well 32 of the well-plate 31 may be supplied with fluid from a different fluid reservoir 12.

Referring again to FIG. 1, in some embodiments, fluid from the fluid reservoir 12 may first be drawn by one or more inlet pumps 18 into a fluid manifold 14, which may separate the fluid from the fluid reservoir 12 onto the fluid inlet lines 16. That is a single first fluid inlet line 13 may fluidically couple the fluid reservoir 12 to the fluid manifold 14, which is then separated to the various fluid inlet lines 16. With reference again to FIG. 2, each fluid reservoir 12a, 12b may be fluidically coupled by a first fluid inlet line 13a, 13b to separate fluid manifolds 14a, 14b, which separates the fluid to the various fluid inlet lines 16 to which the fluid is to be delivered. However, and with reference to both FIGS. 1 and 2, in some embodiments, there may be no fluid manifold upstream of the inlet pumps 18 and, instead, the inlet pumps 18 may pull fluid directly from the fluid reservoir (e.g., 12, 12a, and/or 12b).

Fluid flow through the well-plate manifold 50 may be controlled with the modular pump assembly 15. The modular pump assembly 15 may comprise an array of pumps. The array of pumps may include an array of inlet pumps 18 configured to push fluid through the well-groups of a well-plate, an array of outlet pumps 19 configured to pull fluid through the well-groups 32 of the well-plate 31, and/or any combination thereof. For example, in some embodiments the array of pumps includes an array of pump pairs. Each pump pair may include an inlet pump 18 and an outlet pump 19. A fluid inlet line 16 may fluidically couple the inlet pump 18 to a fluid inlet path 54 of the well-plate manifold 50 and a fluid outlet line 17 may fluidically couple the outlet pump 19 to the fluid outlet path 56 of the well-plate manifold 50. The fluid inlet and outlet lines 16, 17 may be any type of tubing, pipes, etc. for containing fluid flow. The inlet pumps 18 and/or outlet pumps 19 may be any types of pumps including, but not limited to micropumps (e.g., ttpventus BL Series pumps, ttpventus XP Series pumps, ttpventus LT Series pumps, ttpventus HP series pumps, Bartels Mikrotechnik GmbH mp6 micropumps). The inlet pumps 18 and the outlet pumps 19 may be capable of functioning in a small form factor. For example, pumps according to the present disclosure may support low flow rates of 1-2 μl/min. However, greater or smaller flow rates are contemplated and possible.

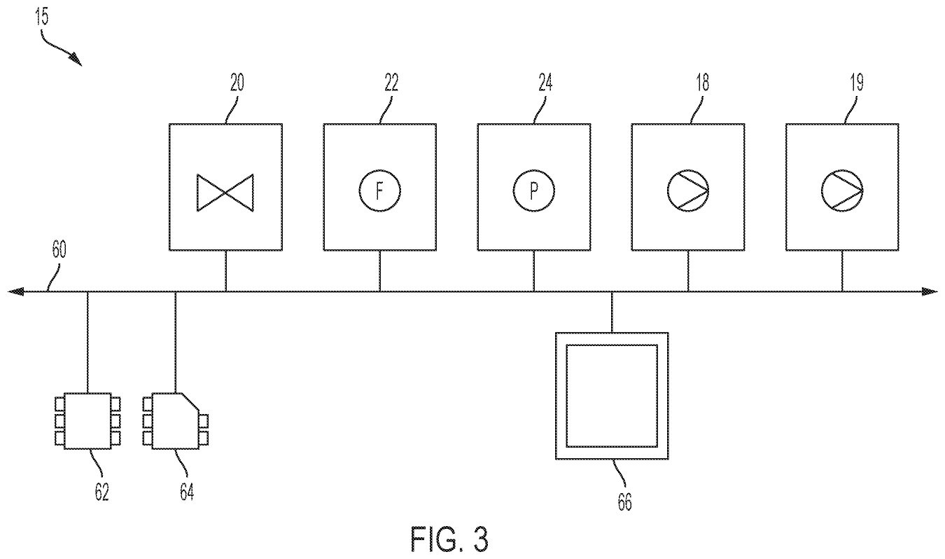

For controlling the flow of fluid through the well-plate assembly 30, each fluid inlet line 16 may include a flow control valve 20, a flow sensor 22, and/or a pressure sensor 24. FIG. 3 schematically illustrates communication between various components of the modular pump assembly 15. For control of fluid flow through the perfusion assembly 10, the modular pump assembly 15 may include a communication path 60, one or more processors 62, one or more memory modules 64, one or more user interface devices 66, each of the inlet pumps 18 and/or each of the outlet pumps 19, the flow control valves 20, the flow sensors 22, and the pressure sensors 24. It is noted that a greater or fewer number of modules may be including without departing from the scope of the present disclosure. It is also noted that not every inlet line 16 may include the same sensors. Additionally, in some embodiments, additional flow sensors, pressure sensors, or the like may measure characteristics of flow through the fluid outlet lines 17.

The communication path 60 provides data interconnectivity between various modules disposed within the modular pump assembly 15. Specifically, each of the modules can operate as a node that may send and/or receive data. In some embodiments, the communication path 60 includes a conductive material that permits the transmission of electrical data signals to processors, memories, sensors, valves, and pumps throughout the modular pump assembly 15. In another embodiment, the communication path 60 can be a bus. In further embodiments, the communication path 60 may be wireless and/or an optical waveguide. Components that are communicatively coupled may include components capable of exchanging data signals with one another such as, for example, electrical signals via conductive medium, electromagnetic signals via air, optical signals via optical waveguides, and the like.

The one or more processors 62 may include any device capable of executing machine-readable instructions (logic) stored on a non-transitory computer-readable medium. Accordingly, each processor may include a controller, an integrated circuit, a microchip, a computer, and/or any other computing device, or any combination thereof.

The one or more memory modules 64 are communicatively coupled to the one or more processors 62 over the communication path 60. The one or more memory modules 64 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. The one or more memory modules 64 may be configured to store one or more pieces of logic, as described in more detail below for controlling flow through the perfusion assembly 10. For example, the one or more pieces of logic may include instructions for operating the inlet pumps 18 and/or the outlet pumps 19, in response to a perfusion criteria stored on the one or more memory modules 64 or otherwise received over the one or more user interface devices 66.

The one or more user interface devices 66 may be communicatively coupled to the one or more processors 62 over the communication path 60. The one or more user interface devices 66 may include any devices that allow a user to interact with the perfusion assembly 10, and more specifically, the modular pump assembly 15. For example, the one or more user interface devices 66 may include any number of displays and/or input devices (e.g., buttons, toggles, knobs, keyboards, microphones, touchscreens, etc.) which allow interaction and exchange of information between the user and the modular pump assembly 15. For example, a user may observe flow parameters (e.g., flow rates, pressures, etc.) through the various inlet and outlet lines 16, 17 and/or input flow parameters (e.g., flow rates, pressures, etc.) to control the inlet pumps 18, outlet pumps 19, and/or flow control valves 20 to adjust the fluid flow parameters through individual inlet and/or outlet lines 16, 17.

The flow control valves 20 may be fluidically coupled to the inlet pumps 18 over the fluid inlet line 16 and communicatively coupled to the one or more processors 62 over the communication path 60. The flow control valves 20 may regulate the fluid flow or pressure of a fluid through the fluid inlet line 16 in response to detected pressure and/or flow rates. For example, the flow control valves 20 may include, but are not limited to, hydraulic valves, pneumatic valves, electronic valves, solenoid valves, etc. One or more of the flow control valves 20 may be actuated, by the one or more processors executing logic stored on the one or more memory modules 64, in response to input received from the one or more user interface devices 66 or feedback from the pressure sensors 24 and/or the flow sensors 22 to adjust flow through the fluid inlet line 16. Flow control valves may be similarly incorporated into the fluid outlet lines 17, if desired.

The fluid flow sensors 22 (e.g., a flow meter) may include any sensor configured to output a flow signal indicative of a fluid flow rate through the fluid inlet line 16. Each fluid inlet line 16 may include one or more fluid flow sensors 22 communicatively coupled to the one or more processors 62 over the communication path 60. The fluid flow sensors 22 may be positioned downstream (e.g., along the fluid inlet line 16) of the inlet pumps 18 and/or the control valves. The one or more processors 62 may execute logic, stored on the one or more memory modules 64, to actuate the flow control valve 20, the inlet pump 18, and/or the outlet pump 136 in response to the flow signal received from the flow sensor 22 to ensure desired flow rates through the perfusion assembly 10 and through the well-group 32. Each fluid inlet line 16 may include a fluid flow sensor 22 such that flow can be independently monitored to each well-group 32 (and/or to each individual well 32). In some embodiments, it is contemplated the fluid flow sensors 22 may be incorporated into the fluid outlet lines 17, if desired, to measure fluid flow rates out of the well-groups 32 and/or each individual well.

The pressure sensors 24 may include any sensor configured to output a pressure signal indicative of pressure within the fluid inlet line 16. Each fluid inlet line 16 may include one or more pressure sensors 24 communicatively coupled to the one or more processors 62 over the communication path 60. The pressure sensors 24 may be positioned downstream (e.g., along the fluid inlet line 16) of the inlet pumps 18 and/or the control valves. The one or more processors 62 may execute logic, stored on the one or more memory modules 64, to actuate the flow control valve 20, the inlet pump 18, and/or the outlet pump 19 in response to the pressure signal received from the pressure sensor 24 to ensure desired flow through the perfusion assembly 10 and through the well-group 32. Each fluid inlet line 16 may include a pressure sensor such that pressure can be independently monitored to each well-group 32 (and/or to each individual well 32). In some embodiments, it is contemplated the pressure sensors 24 may be incorporated into the fluid outlet lines 17, if desired, to measure fluid pressure within the fluid outlet lines 17.

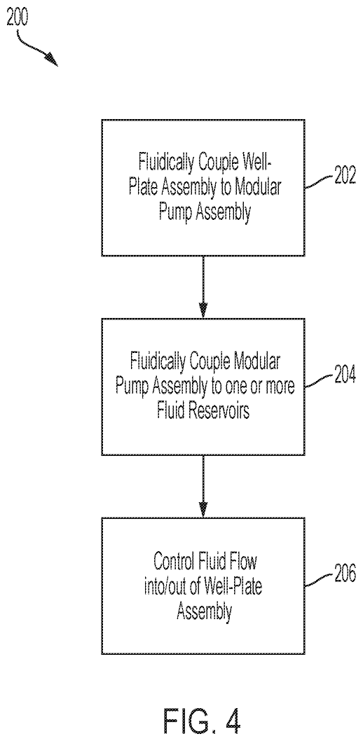

FIG. 4 depicts a flow chart illustrating as method 200 of delivering fluid to a well-plate assembly 30 such as described above, according to one or more embodiments. It is noted that though only three steps (e.g., steps 202, 204, and 206) are depicted, a greater or fewer number of steps, in any order, may be included without departing from the scope of the present disclosure.

At step 202, the method 200 includes fluidically coupling the well-plate assembly 30 to the modular pump assembly 15. Such may include attaching the fluid inlet lines 16 to fluid inlet paths 54 of the well-plate manifold 50 to fluidically couple the fluid inlet paths 54 of the well-plate manifold 50 to the inlet pumps 18. At step 204, the method 200 further includes fluidically coupling the modular pump assembly 15 to one or more fluid reservoirs 12. As noted above, each inlet pump 18 of the modular pump assembly 15 may be fluidically coupled to separate fluid reservoirs 12 or the same fluid reservoir 12. In some embodiments, a portion of the inlet pumps 18 may be fluidically coupled to a first fluid reservoir 12a and a second portion of the inlet pumps 18 may be fluidically coupled to a second fluid reservoir 12b that is different from the first fluid reservoir 12a, such as illustrated in FIG. 2. In some embodiments, one or more fluid manifolds 14 fluidically couple the one or more fluid reservoirs 12 to the inlet pumps 18 of the modular pump assembly 15.

Step 206 includes controlling fluid flow into/out of the well-plate assembly 30. That is, the inlet/outlet pumps 19 may be primed with the desired media/solution for an experimental procedure, for example. Accordingly, the outlet pumps 19 may be fluidically coupled to the outlet pumps 19 of the modular pump assembly 15 through fluid outlet line 17. The outlet pumps 19 may deliver fluid into a receptacle 11 (e.g., a waste receptacle) or other location for further processing. For example, the one or more processors 62 may execute instructions received over the one or more user interface devices 66 and/or by executing logic stored on the one or more memory modules 64, to selectively activate a pump (e.g., the inlet pump 18 and/or the outlet pump 19) of a pump pair associated of the one or more well-groups 32 to cause fluid to flow through one or more of the well-groups 32. In some embodiments, controlling fluid flow further includes detecting fluid flow parameters (e.g., flow rate with the fluid flow sensors 22 and/or pressure with the fluid pressure sensors 24) within the fluid inlet lines 16 fluidically coupling the inlet pumps 18 to the fluid inlet path 54 of the well-plate manifold 50 and adjusting (e.g., automatically) fluid flow parameters (e.g., with the inlet pump 18, outlet pump 19, and/or control valve 20) to the fluid inlet path 54 in response to the detected fluid flow parameters. That is, fluid flow rates and/or pressures may be adjusted to stay within predetermined limits. For example, fluid flow rates may be controlled to be less than about 6 ml/min or between about 1 nl/min to about 1000 μl/m. In particular, fluid flow rates may be controlled to be similar to fluid flowrates within a physiological vasculature. For example, in some embodiments flow rates may be controlled to be between about 150 to about 300 μl/min. However, other flow rates are contemplated and possible. Similarly, pressure parameters may similarly be controlled to be aligned with physiological blood pressures (e.g., 180/120, 110/70, etc). In some embodiments, pressure parameters may be similar to physiological capillary blood pressures (e.g., 0.5 to 22.5 mmHg). However, other pressure parameters are contemplated and possible.

For example, the method 200 may include detecting a fluid pressure within a fluid inlet line 16 fluidically coupling the inlet pump 18 to a fluid inlet path 54 of the well-plate manifold 50 and adjusting a flow control valve 20 positioned along the fluid inlet line 16 to adjust the fluid pressure within the fluid inlet line 16 in response to the detected fluid pressure. As another example, the method 200 may include detecting a fluid flow rate within a fluid inlet line 16 fluidically coupling the inlet pump 18 to a fluid inlet path 54 of the well-plate manifold 50, and adjusting a flow control valve 20 positioned along the fluid inlet line 16 to adjust the fluid flow rate within the fluid inlet line 16 in response to the fluid flow rate.

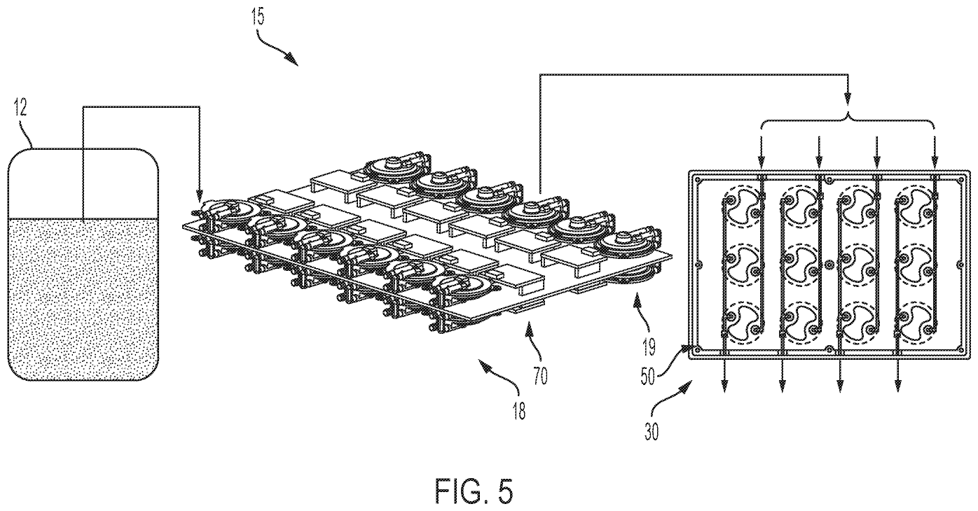

FIG. 5 schematically illustrates an embodiment of a modular pump assembly 15 fluidically coupling a fluid reservoir 12 to a well-plate manifold 50. In this particular embodiment, the modular pump assembly 15 includes a mounting frame 70 to which an array of pump pairs 102 is mounted. Each of the pump pairs includes an inlet pump 18 and an outlet pump 19. The frame 70 may be a printed circuit board onto which the array of pump pairs may be physically and electronically mounted. Is noted that while the modular pump assembly 15 illustrates the inlet pumps 18 along a first side of the frame 70 and the outlet pumps 19 arranged along a second side of the frame 70, in some embodiment, the inlet pumps 18 may be arranged along a top surface of the frame 70 while the outlet pumps 19 are arranged along a bottom surface of the frame 70 opposite the inlet pumps 18. It is noted that the frame 70 may be sized to house any number of pump pairs (e.g., 6 pumps pair, 8 pump pairs, 12 pumps pairs, etc.). In some embodiments, the inlet and outlet pumps 18, 19 may be pluggable and unpluggable onto the frame 70 to allow for customization of the number of pump pairs 102 arranged on the frame 70.

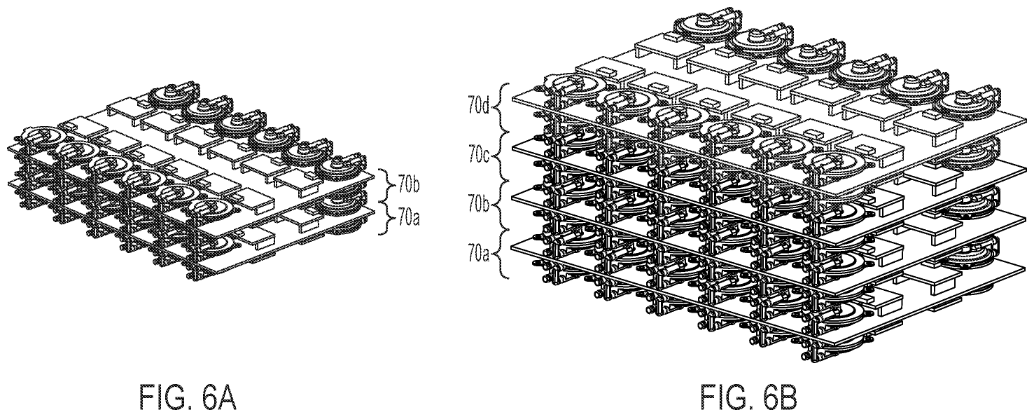

As illustrated in FIGS. 6A and 6B additional frames (e.g., 70a, 70b, 70c, and 70d) may be stackable with one another in a modular configuration such that any desired number of frames may be stacked together to provide an adjustable form factor. For example, FIG. 6A illustrates a first frame 70a stacked with a second frame 70b. FIG. 6B illustrates a first frame 70a, a second frame 70b, a third frame 70c, and a fourth frame 70d vertically stacked on top of one another. Accordingly, any number of pumps may be provided in a compact structure for perfusion of a well-plate assembly 30. For example, frames with twelve pump pairs may be stacked to provide capacity to individually control perfusion into 12 wells, 24 wells, 48 wells, 96 wells, etc.

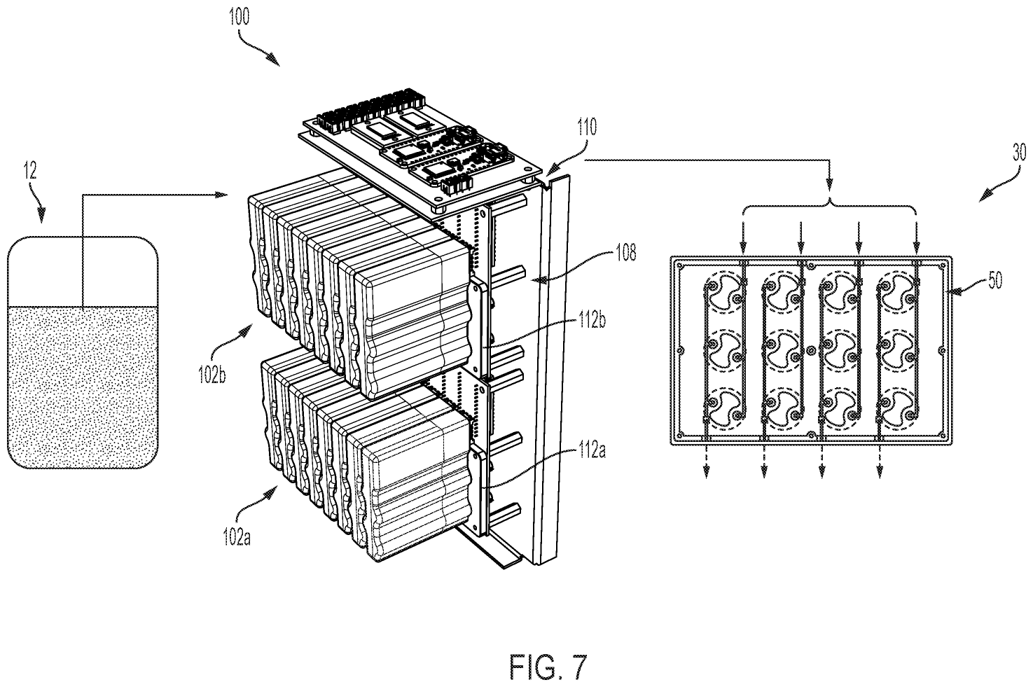

FIG. 7 illustrates an alternative modular pump assembly 100 for fluidically coupling the fluid reservoir 12 to the well-plate manifold 50. Unless otherwise noted, the above description in regards to FIGS. 1-4 is applicable to the present embodiment unless otherwise specifically noted or apparent from the description and/or figures.

In particular, the modular pump assembly 100 includes housing 110, an array of pump pairs 102a and/or 102b, wherein each pump pair is arranged within an enclosure that is pluggable into a mounting frame 112a, 112b.

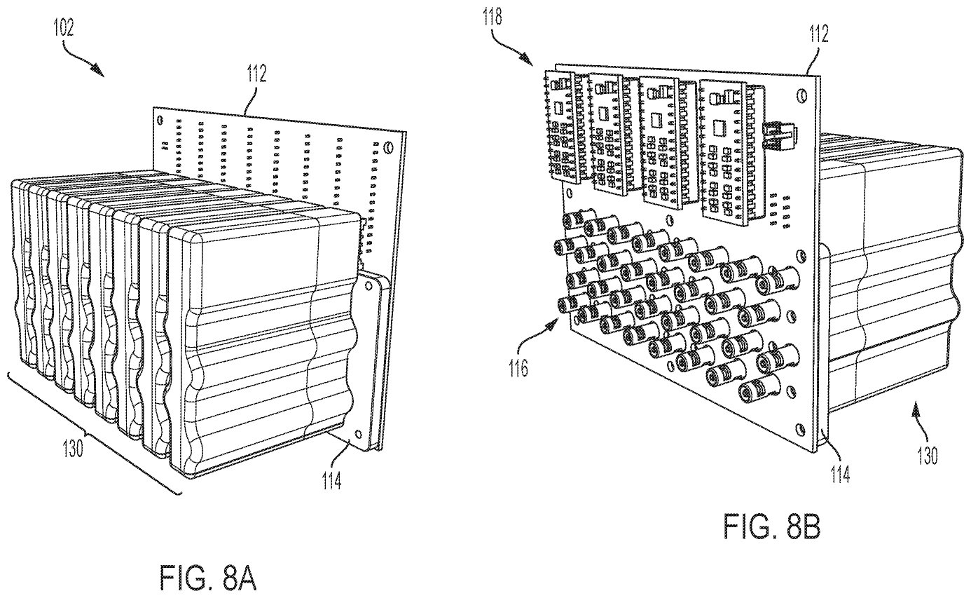

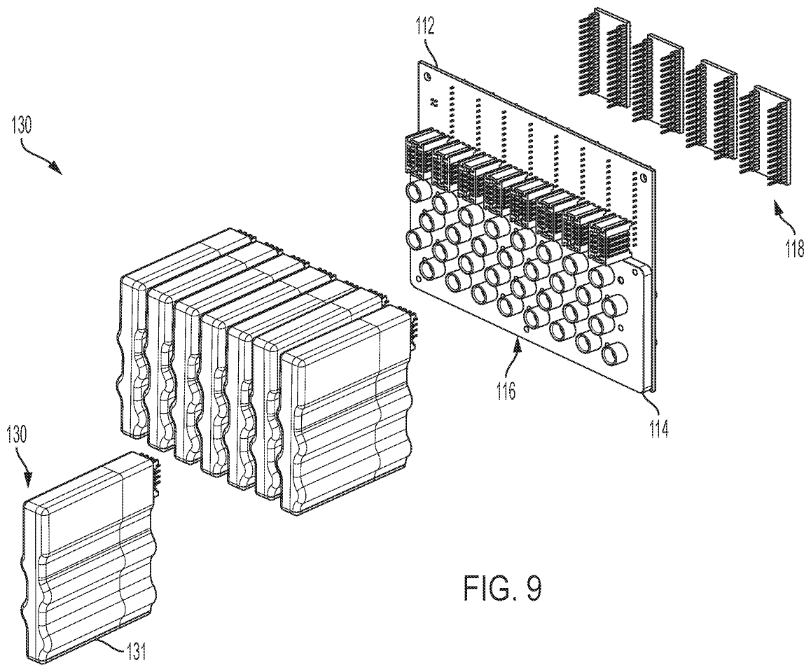

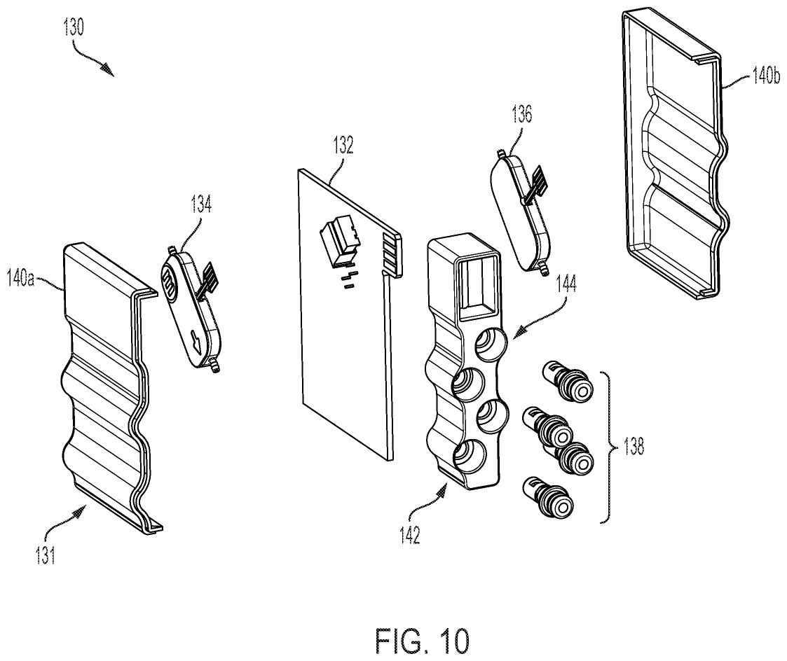

FIGS. 8A and 8B illustrate a more detailed view of an array of pump pairs 102 mounted to a mounting frame 112. The arrays of pump pairs 102 may include a plurality of cartridges 130 that house each pump pair therein. The frame 112 may be a printed circuit board 132 that couples the plurality of cartridges 130 to micropump drive boards 118, which may form part of the one or more processors 62 and/or memory modules 64 described above. The frame 112 includes a plurality of fluid couplings 116 (e.g., nozzles, quick-connect ports, or the like) for fluidically coupling the cartridges 130 to fluid inlet and outlet lines 16, 17 (not shown), described above. FIG. 9 illustrates an exploded view of the plurality of cartridges 130 from the mounting frame 112. In the illustrated embodiment, the frame 112 includes a fluid distribution board 114 that fluidly couples inlet and outlet openings 144 and/or flow connectors 138 (illustrated in FIG. 10) of the cartridges 130 to the plurality of fluid couplings 116 shown in FIG. 8B.

Referring now to FIG. 10 a cartridge 130 of the plurality of cartridges 130 is illustrated in an exploded view. In this view, the cartridge 130 includes an enclosure 131, an inlet pump 134, an outlet pump 136, and a printed circuit board 132. It is noted that tubing has been removed for simplicity of illustration.

The enclosure 131 may be separable into a first side wall 140a and a second side wall 140b. The housing 131 further includes a fluid communication end wall 142. Together the first side wall 140a, the second side wall 140b, and the fluid communication end wall 142 form the enclosure 131 around the inlet pump 134, the outlet pump 136, and the printed circuit board 132. The fluid communication end wall 142 may include a plurality of opening 144 through which the inlet and outlet lines may be attached. For example, the inlet pump 134 may draw fluid from the fluid reservoir 12 over the first fluid inlet line 13 (or a line from the fluid manifold 14 illustrated in FIG. 1) and pump fluid into the fluid inlet line 16 and into the well-plate manifold 50 described above. The outlet pump 136 may draw fluid from the well-plate manifold 50 into the outlet line, which may then dump the fluid into a receptacle 11. To accomplish this, the plurality of openings 144 of the fluid communication end wall may have flow connectors 138 positioned therein that are fluidically coupled to inlet and outlets of the pumps 134, 136 with tubing, not shown for simplicity. The flow connectors 138 may plug into the fluid distribution board 114 of the frame 112, shown in FIG. 9.

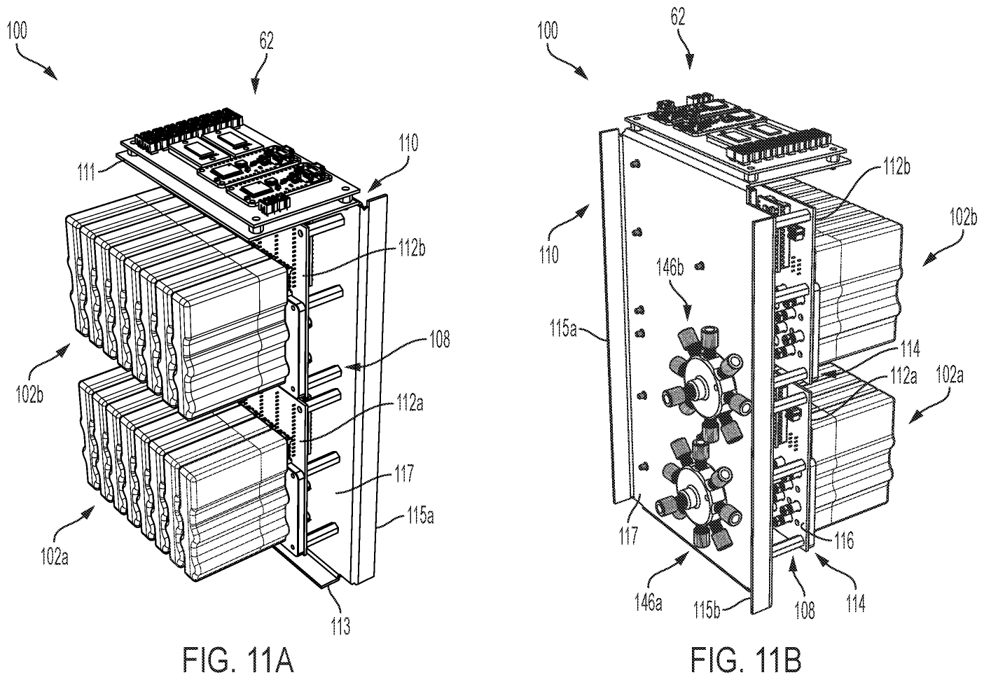

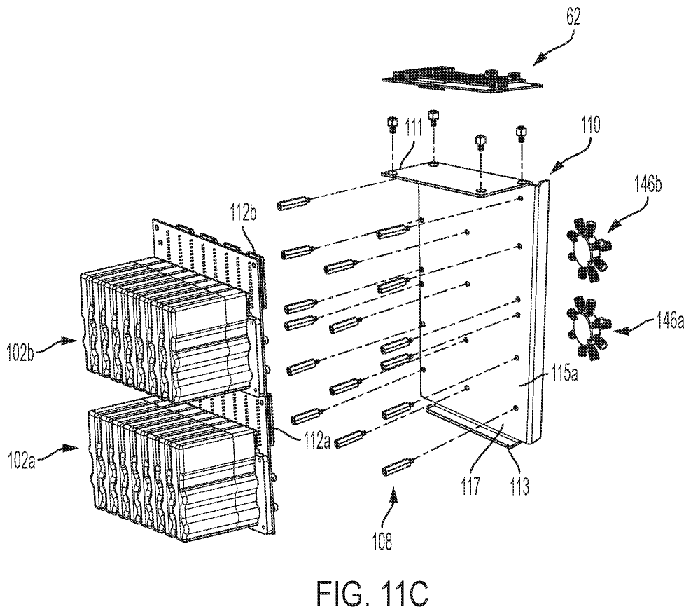

Referring now to FIG. 11A-11C, the arrays of pump pairs 102a, 102b may be mounted to the housing 110 through a plurality of standoff pins 108. The standoff pins may form a space between the housing 110 and the mounting frames 112a to allow room for tubing to be run to the various cartridges 130.

Referring to FIG. 11C, the housing 110 includes a top flange 111, a first and second side flanges 115a, 115b, a base flange 113, and a back wall 117. It is noted that multiple housings 110 may be bonded or stacked together in any direction to provide support to additional arrays of pump pairs. For example, additional housings may be coupled to on another along the top flange 111, the first and/or second side flanges 115a, 115b, and/or the base flange 113. In some embodiments, additional housings 110 may simply be stacked on another such that the arrays of pump pairs 102a, 102b support subsequent layers of modular pump assemblies 100. In some embodiments, the top flange 111 may provide a support surface for supporting one or more processors 62 and/or one or more memory modules 64 as described herein.

As noted above, the arrays of pump pairs 102a, 102b may be mounted to the housing 110. In particular, the array of pump pairs 102a, 102b may be bounded to the back wall 117 by the plurality standoff pins 108 such that the mounting frames 112a, 112b of the array of pump pairs 102, 102b are spaced from the back wall 117.

In some embodiments mounted to the opposite side of the back wall 117, opposite the arrays of pump pairs 102a, 102b, may be one or more fluid manifolds 146a, 146b. These fluid manifolds 146a, 146b may be similar to those described in regards to FIG. 1 or 2, wherein a first fluid inlet line 13 delivers fluid to the fluid manifolds 146a, 146b, which is then split to the individual inlet pumps.

It is noted that any embodiments as provided herein may be integrated into an automated assembly (e.g., BioAssemblyBot® 3-D Printing and Robotics Systems such as described in U.S. patent application Ser. No. 15/726,617, filed Oct. 6, 2017, entitled “System and Method for a Quick-Change Material Turret in a Robotic Fabrication and Assembly Platform,” hereby incorporated by reference in its entirety and as available from Advanced Solutions Life Sciences, LLC of Louisville, Ky., and/or automated storage assemblies such as described in U.S. Patent Application No. 16/502,795, entitled “Modular Storage Units for Perfusion and/or Incubation of One or More Specimens and Storage Assemblies,” filed Jul. 3, 2019, hereby incorporated by reference in its entirety). However, the assemblies as described herein may also be used in manual benchtop applications.

It is noted that in the various embodiments described herein the various parts, for example, the pumps, frames, tubes, sensors, valves, etc., may be sterilizable for repeated use and/or use in different experiments.

Additionally embodiments of the present disclosure may have a small overall size such that an entire modular pump assembly 100 may sit on or below a well-plate assembly 30 or within another limited storage area. However, it is noted that larger assemblies are contemplated and possible.

Embodiments can be described with reference to the following numbered clauses, with preferred features laid out in the dependent clauses:

1. A modular pump assembly comprising: a plurality of mounting frames configured to be stackable with one another in a modular configuration; and an array of pump mounted to each of the plurality mounting frames, the array of pumps comprising an array of inlet pumps configured to be fluidically coupled a plurality of fluid inlet paths of a well-plate manifold or an array of fluid outlet pumps configured to be fluidically coupled to a plurality of fluid outlet paths of the well-plate manifold, or any combination thereof

2. The modular pump assembly of clause 1, wherein the array of pumps comprises an array of pump pairs, each pump pair comprising an inlet pump and an outlet pump.

3. The modular pump assembly of any preceding clause, further comprising one or more processors communicatively coupled to the inlet pump and the outlet pump; and one or more memory modules that store logic that when executed by the one or more processors cause the one or more processors to: control the inlet pump to deliver fluid from a fluid reservoir to a well of a well-plate; and control the outlet pump to remove the fluid from the fluid reservoir of the well of the well-plate.

4. The modular pump assembly of clause 3, further comprising: a flow control valve fluidically coupled to the inlet pump and communicatively coupled to the one or more processors, wherein the one or more processors execute logic to actuate the flow control valve to control a flow of fluid from the inlet pump to the well of the well-plate.

5. The modular pump assembly of clause 4, further comprising: a flow sensor configured to output a flow signal indicative of a flow rate of fluid between the inlet pump and the well of the well-plate, wherein the one or more processors execute logic to actuate the flow control valve in response to the flow signal received from the flow sensor.

6. The modular pump assembly of any of clauses 3-5, further comprising: a pressure sensor configured to output a pressure signal indicative of pressure within a fluid inlet line extending from the inlet pump to a well of the well-plate, wherein the one or more processors execute logic to actuate the flow control valve in response to the pressure signal received from the pressure sensor.

7. The modular pump assembly of any of clauses 2-6, further comprising an enclosure housing each pump pair.

8. A perfusion assembly, comprising: a well-plate assembly comprising: a well-plate defining a plurality of well-groups each comprising one or more wells; and a well-plate manifold comprising a plurality of fluid inlet paths and fluid outlet paths corresponding to each well-group; a modular pump assembly comprising: a plurality of mounting frames configured to be stackable with one another in a modular configuration; an array of pumps mounted to each of the plurality mounting frames, the array of pumps comprising an array of inlet pumps fluidically coupled to the plurality of fluid inlet paths, an array of outlet pumps fluidically coupled to plurality of fluid outlet paths, or any combination thereof.

9. The perfusion assembly of clause 8, wherein the array of pumps comprises an array of pump pairs, each pump pair comprising an inlet pump and an outlet pump.

10. The perfusion assembly of clause 8 or 9, further comprising: one or more processors communicatively coupled to the inlet pump and the outlet pump; and one or more memory modules that store logic that when executed by the one or more processors cause the one or more processors to: control the inlet pump to deliver fluid from a fluid reservoir to a well-group of the well-plate; and control the outlet pump to remove the fluid from the well-group of the well-plate.

11. The perfusion assembly of clause 10, wherein the modular pump assembly further comprises: a flow control valve fluidically coupled to the inlet pump by a fluid inlet line and communicatively coupled to the one or more processors, wherein the one or more processors execute logic to actuate the flow control valve to control a flow of fluid from the inlet pump to the well-group of the well-plate.

12. The perfusion assembly of clause 10 or 11, wherein the modular pump assembly further comprises: a flow sensor configured to output a flow signal indicative of a flow rate of fluid within the fluid inlet line, wherein the one or more processors execute logic to actuate the flow control valve in response to the flow signal received from the flow sensor.

13. The perfusion assembly of any of clauses 10-12, wherein the modular pump assembly further comprises: a pressure sensor configured to output a pressure signal indicative of pressure within the fluid inlet line extending from the inlet pump to the well of the well-plate, wherein the one or more processors execute logic to actuate the flow control valve in response to the pressure signal received from the pressure sensor.

14. The perfusion assembly of any of clauses 9-12, wherein each pump pair is arranged within an enclosure.

15. A method of delivering fluid to a well-plate assembly, the method comprising: fluidically coupling the well-plate assembly to a modular pump assembly, wherein: the well-plate assembly comprises a well-plate defining a plurality of well-groups each comprising one or more wells; and a well-plate manifold comprising a plurality of fluid inlet paths and fluid outlet paths corresponding to each well-group; and the modular pump assembly comprises: one or more mounting frames; and an array of pumps mounted to the one or more mounting frames, the array of pumps comprising an array of inlet pumps fluidically coupled to the plurality of fluid inlet paths, an array of outlet pumps fluidically coupled to plurality of fluid outlet paths, or any combination thereof; fluidically coupling the modular pump assembly to one or more fluid reservoirs; and controlling fluid flow into and/or out of one or more of the well-groups by selectively activating, with one or more processors, a pump of the array of pumps associated with each of the well-groups.

16. The method of clause 15, further comprising: detecting fluid flow parameters within a fluid inlet line fluidically coupling a fluid reservoir to the well-plate manifold; and adjusting fluid flow parameters to a fluid inlet path in response to detected fluid flow parameters.

17. The method of clause 15 or 16, further comprising: detecting a fluid pressure within a fluid inlet line fluidically coupling the one or more fluid reservoirs to the well-plate manifold; and adjusting a control valve positioned along the fluid inlet line to adjust the fluid pressure within the fluid inlet line in response to the fluid pressure.

18. The method of any of clauses 15-17, further comprising: detecting a fluid flow rate within a fluid inlet line fluidically coupling the one or more fluid reservoirs to the well-plate manifold; and adjusting a control valve positioned along the fluid inlet line to adjust the fluid flow rate within the fluid inlet line in response to the fluid flow rate.

19. The method of any of clauses 15-18, further comprising fluidically coupling a fluid reservoir to each of the one or more of the inlet pumps.

20. The method of any of clauses 15-19, further comprising fluidically coupling a portion of the inlet pumps to a first fluid reservoir; and fluidically coupling a second portion of the inlet pumps to a second fluid reservoir that is different from the first fluid reservoir.

It should now be understood that embodiments as described herein are directed to a modular and expandable low flow pumping solution for discrete flow control and integration into multichannel perfusion networks. Pumping solutions and assemblies may incorporate, but are not limited to, an array of pumps, valves, flow sensors, and/or pressure sensors to supply discrete flow to each well of a well-plate or discrete groups of wells in a well-plate. The unit may be devised to be a modular construct so that it can be expandable to larger array of hardware to accommodate each well-plate capacity. Accordingly, individualized perfusion control of any number of wells in a well-plate may be realized.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A modular pump assembly comprising:
a plurality of mounting frames configured to be stackable with one another in a modular configuration; and
an array of pumps mounted to each of the plurality mounting frames, the array of pumps comprising an array of inlet pumps configured to be fluidically coupled a plurality of fluid inlet paths of a well-plate manifold or an array of fluid outlet pumps configured to be fluidically coupled to a plurality of fluid outlet paths of the well-plate manifold, or any combination thereof.

2. The modular pump assembly of claim 1, wherein the array of pumps comprises an array of pump pairs, each pump pair comprising an inlet pump and an outlet pump.

3. The modular pump assembly of claim 2, further comprising:
one or more processors communicatively coupled to the inlet pump and the outlet pump; and
one or more memory modules that store logic that when executed by the one or more processors cause the one or more processors to:
control the inlet pump to deliver fluid from a fluid reservoir to a well of a well-plate; and
control the outlet pump to remove the fluid from the fluid reservoir of the well of the well-plate.

4. The modular pump assembly of claim 3, further comprising:
a flow control valve fluidically coupled to the inlet pump and communicatively coupled to the one or more processors, wherein the one or more processors execute logic to actuate the flow control valve to control a flow of fluid from the inlet pump to the well of the well-plate.

5. The modular pump assembly of claim 4, further comprising:
a flow sensor configured to output a flow signal indicative of a flow rate of fluid between the inlet pump and the well of the well-plate, wherein the one or more processors execute logic to actuate the flow control valve in response to the flow signal received from the flow sensor.

6. The modular pump assembly of claim 4, further comprising:
a pressure sensor configured to output a pressure signal indicative of pressure within a fluid inlet line extending from the inlet pump to a well of the well-plate, wherein the one or more processors execute logic to actuate the flow control valve in response to the pressure signal received from the pressure sensor.

7. The modular pump assembly of claim 2, further comprising an enclosure housing each pump pair.

8. A perfusion assembly, comprising:
a well-plate assembly comprising:
a well-plate defining a plurality of well-groups each comprising one or more wells; and
a well-plate manifold comprising a plurality of fluid inlet paths and fluid outlet paths corresponding to each well-group;
a modular pump assembly comprising:
a plurality of mounting frames configured to be stackable with one another in a modular configuration;
an array of pumps mounted to each of the plurality mounting frames, the array of pumps comprising an array of inlet pumps fluidically coupled to the plurality of fluid inlet paths, an array of outlet pumps fluidically coupled to plurality of fluid outlet paths, or any combination thereof.

9. The perfusion assembly of claim 8, wherein the array of pumps comprises an array of pump pairs, each pump pair comprising an inlet pump and an outlet pump.

10. The perfusion assembly of claim 9, further comprising
one or more processors communicatively coupled to the inlet pump and the outlet pump; and
one or more memory modules that store logic that when executed by the one or more processors cause the one or more processors to:
control the inlet pump to deliver fluid from a fluid reservoir to a well-group of the well-plate; and
control the outlet pump to remove the fluid from the well-group of the well-plate.

11. The perfusion assembly of claim 10, wherein the modular pump assembly further comprises:
a flow control valve fluidically coupled to the inlet pump by a fluid inlet line and communicatively coupled to the one or more processors, wherein the one or more processors execute logic to actuate the flow control valve to control a flow of fluid from the inlet pump to the well-group of the well-plate.

12. The perfusion assembly of claim 11, wherein the modular pump assembly further comprises:
a flow sensor configured to output a flow signal indicative of a flow rate of fluid within the fluid inlet line, wherein the one or more processors execute logic to actuate the flow control valve in response to the flow signal received from the flow sensor.

13. The perfusion assembly of claim 11, wherein the modular pump assembly further comprises:
a pressure sensor configured to output a pressure signal indicative of pressure within the fluid inlet line extending from the inlet pump to the well of the well-plate, wherein the one or more processors execute logic to actuate the flow control valve in response to the pressure signal received from the pressure sensor.

14. The perfusion assembly of claim 9, wherein each pump pair is arranged within an enclosure.

15. A method of delivering fluid to a well-plate assembly, the method comprising:
fluidically coupling the well-plate assembly to a modular pump assembly, wherein:
the well-plate assembly comprises a well-plate defining a plurality of well-groups each comprising one or more wells; and
a well-plate manifold comprising a plurality of fluid inlet paths and fluid outlet paths corresponding to each well-group; and
the modular pump assembly comprises:
one or more mounting frames; and
an array of pumps mounted to the one or more mounting frames, the array of pumps comprising an array of inlet pumps fluidically coupled to the plurality of fluid inlet paths, an array of outlet pumps fluidically coupled to plurality of fluid outlet paths, or any combination thereof;
fluidically coupling the modular pump assembly to one or more fluid reservoirs; and
controlling fluid flow into and/or out of one or more of the well-groups by selectively activating, with one or more processors, a pump of the array of pumps associated with each of the well-groups.

16. The method of claim 15, further comprising:
detecting fluid flow parameters within a fluid inlet line fluidically coupling a fluid reservoir to the well-plate manifold; and
adjusting fluid flow parameters to a fluid inlet path in response to detected fluid flow parameters.

17. The method of claim 15, further comprising:
detecting a fluid pressure within a fluid inlet line fluidically coupling the one or more fluid reservoirs to the well-plate manifold; and
adjusting a control valve positioned along the fluid inlet line to adjust the fluid pressure within the fluid inlet line in response to the fluid pressure.

18. The method of claim 15, further comprising:
detecting a fluid flow rate within a fluid inlet line fluidically coupling the one or more fluid reservoirs to the well-plate manifold; and
adjusting a control valve positioned along the fluid inlet line to adjust the fluid flow rate within the fluid inlet line in response to the fluid flow rate.

19. The method of claim 15, further comprising fluidically coupling a fluid reservoir to each of the one or more of the inlet pumps.

20. The method of claim 15, further comprising fluidically coupling a portion of the inlet pumps to a first fluid reservoir and fluidically coupling a second portion of the inlet pumps to a second fluid reservoir that is different from the first fluid reservoir.
